(19) United States
(12) Patent Application Publication
(10) Pub. No.: US 2009/0091948 A1
(43) Pub. Date: Apr. 9, 2009

(54) LIGHT SOURCE MODULE

(75) Inventors: MENG-HUA WANG, Chu-Nan (TW); FENG-CHENG CHUNG, Chu-Nan (TW); HUNG-KUANG HSU, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/192,041

(22) Filed: Aug. 14, 2008

(30) Foreign Application Priority Data
Oct. 9, 2007 (CN) 200710201972.7

(51) Int. Cl. F21V 7/04

(52) U.S. Cl. 362/613

(57) ABSTRACT

An exemplary light source module includes a plurality of light emitting units and a light pervious paste. Each light emitting unit includes a light guide plate and a light source optically coupled to the light guide plate. The light guide plate includes a bottom surface, a light emitting surface opposite to the bottom surface, and a plurality of side surfaces interconnected between the bottom surface and the light emitting surface. The light pervious paste is interconnected between two adjacent side surfaces of two neighboring light guide plates.

### BACKGROUND

1. Technical Field

The present invention relates to a light source module, and particularly, to light source modules formed by joining a plurality of light emitting units.

2. Description of Related Art

Large-sized light source modules have been widely used in large-sized billboards, large-sized display, and so on. Sometimes, in order to obtain a large-sized light source module, a plurality of light emitting units is joined together.

When joining surfaces of two adjacent light source modules are rough, the two adjacent light source modules can not be closely united, and inevitably, an air gap exits between the two adjacent light source modules. Therefore, the light energy loss may occur due to light reflection on the joining surfaces of the two adjacent light source modules. The light emitted from a light emitting unit can not be efficiently coupled into an adjacent light emitting unit. As a result, uniformity of the brightness of the overall light source module is insufficient. Furthermore, the brightness of the overall light source module is decreased.

Therefore, a new light source module is desired to overcome the above mentioned problems.

### SUMMARY

An exemplary light source module includes a plurality of light emitting units and a light pervious paste. Each light emitting unit includes a light guide plate and a light source optically coupled to the light guide plate. The light guide plate includes a bottom surface, a light emitting surface opposite to the bottom surface, and a plurality of side surfaces interconnected between the bottom surface and the light emitting surface. The light pervious paste is interconnected between two adjacent side surfaces of two neighboring light guide plates

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, perspective view of a light source module, according to a first embodiment.

FIG. 2 is a schematic, plan view of a light emitting unit according to a first embodiment.

FIG. 3 is a schematic, side cross-sectional view of the light emitting unit of FIG. 2 taken along the line Ill-Ill thereof.

FIG. 4 is a schematic, side cross-sectional view of a light emitting unit, according to a second embodiment.

### DETAILED DESCRIPTION OF THE EMBODIMENTS

Embodiments will now be described in detail below with reference to the drawings.

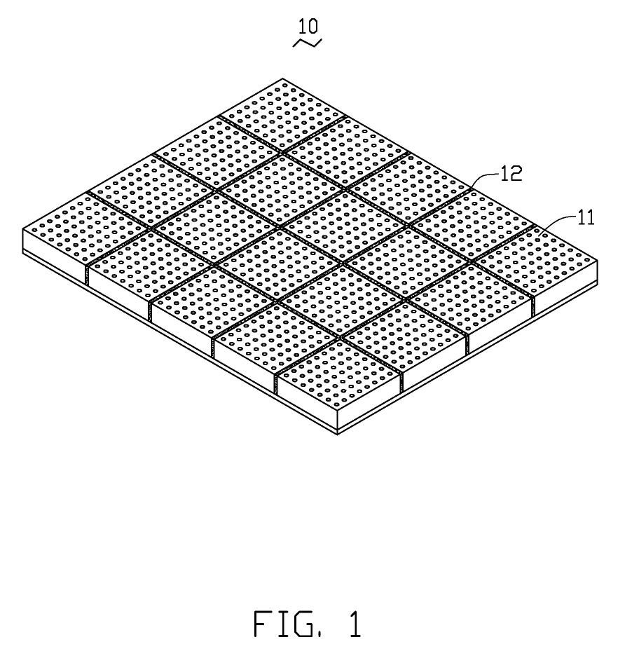

Referring to FIG. 1, a light source module 10 according to a first embodiment is shown. The light source module 10 includes a plurality of light emitting units 11. Two adjacent light emitting units 11 cooperatively define a gap (not labeled) therebetween, and the gap is completely filled by a light pervious paste 12. Every two adjacent light emitting units 11 are connected by the light pervious paste 12.

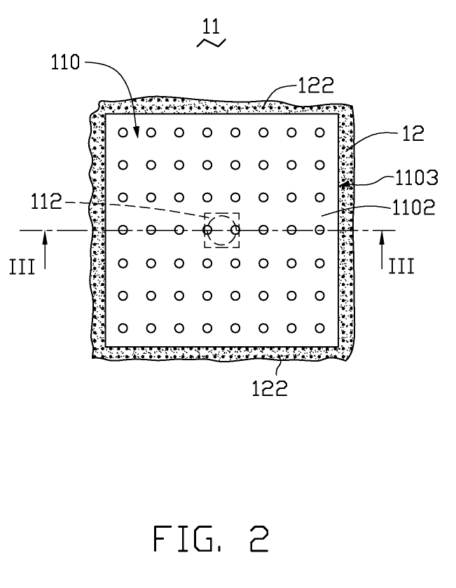

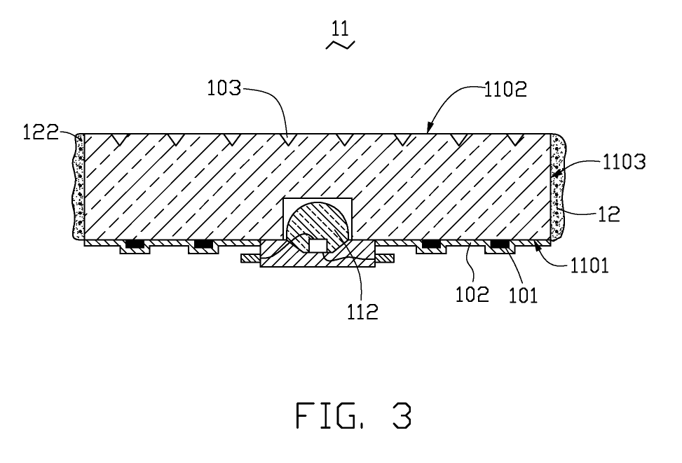

Referring to FIGS. 2 and 3, the light emitting unit 11 includes a light guide plate (LGP) 110, and a light source 112 optically coupling with the light guide plate 110. The LGP 110 includes a bottom surface 1101, a light emitting surface 1102, and a plurality of side surfaces 1103 connected between the bottom surface 1101 and the light emitting surface 1102. The LGP 110 can be square, rectangular, triangular or other suitable shapes. The LGP 110 can be made of polymethyl methacrylate (PMMA), polycarbonate (PC), or acrylic glass.

The bottom surface 1101 has a plurality of scattering dots 101 and a reflective layer 102 formed thereon. The scattering dots 101 are configured for scattering light beams reaching the scattering dots 101. The reflective layer 102 covers the scattering dots 101 and the bottom surface 1101. The reflective layer 102 reflects light beams from the LGP 110 back to the LGP 110 so that the efficiency of the light emitting unit 11 is increased.

The light emitting surface 1102 has a plurality of microstructures 103 formed thereon to enhance uniformity of the light emitting from the light emitting surface 1102. In the present embodiment, the microstructures 103 are V-shaped recesses.

The four side surfaces 1103 each have a light pervious paste 12 applied thereon. The light pervious paste 12 has a high light transmittance ability, and a good adhesive ability. In the present embodiment, the light pervious paste 12 is an ultraviolet (UV) cured paste. A refractive index of the light pervious paste 12 should match a refractive index of the LGP 110. That is, the refractive index of the light pervious paste 12 should be approximate to that of the LGP 110. Hence, losses of light caused by reflection on the side surfaces 1103 are decreased. When a difference between the refractive index of the light pervious paste 12 and that of the LGP 110 is less than 0.1, the losses of light caused by reflection on the side surfaces 1103 are greatly decreased. Referring to FIG. 2, all of the four side surfaces 1103 of the LGP 110 have the light pervious pastes 12 formed thereon. It should be noted that the light pervious paste 12 may be applied on only two or three side surfaces 1103 of the LGP 110 depending on the number of side surfaces of the LGP 110 adjoin with other light emitting unit 11.

The light pervious paste 12 may have a plurality of highly reflective particles 122 evenly dispersed therein. The reflective particles 122 scatter the light in the light pervious paste. As a result, the brightness of the light pervious paste 12 is more uniform and is increased. The reflective particles 122 can be silicon dioxide particles and other suitable particles.

The LGP 110 has a recess defined in the center of the bottom surface 1101. Part of the light source 112 is received in the recess. In the present embodiment, the light source 112 is a light emitting diode (LED).

The gap cooperatively defined between every two adjacent light emitting units 11 are completely filled by the light pervious paste 12. Thus, an air gap between the two light emitting units 11 is eliminated. Hence, light energy losses caused by light reflection on the side surfaces 1103 are decreased. Accordingly, the light emitted from the first light emitting unit 11 can be efficiently coupled into the adjacent second light emitting unit 11. Likewise, the light emitted from the second light emitting unit 11 can be efficiently coupled into the adjacent first light emitting unit 11. As a result, the brightness of the overall light source module 10 is more uniform. Furthermore, the brightness of the overall light source module 10 is increased.

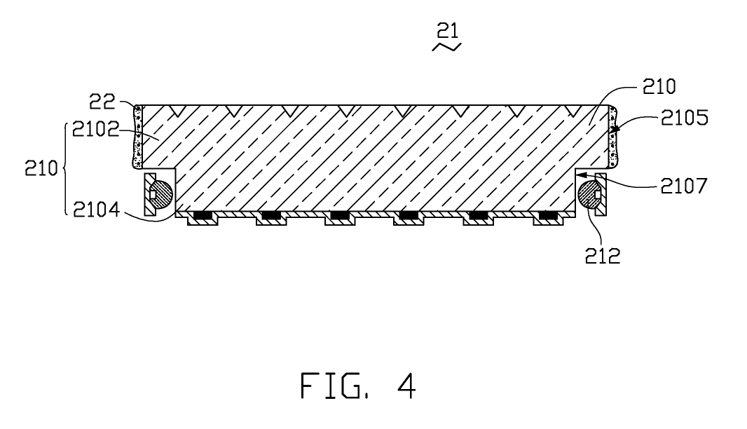

Referring to FIG. 4, a light emitting unit 21 according to a second embodiment is shown. The light emitting unit 21 includes an LGP 210 and two light sources 212. The LGP 210 includes an upper part 2102 and a lower part 2104. The upper part 2102 includes a first side surface 2105 for joining with another light emitting unit 21, and the lower part 2104 has a second side surface 2107 for receiving light emitted from the light source 212. The first side surface 2105 has a light pervious paste 22 formed thereon. The light sources 212 are adjacent to the second side surfaces 2107.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A light source module comprising:
a plurality of light emitting units, each light emitting unit comprising a light guide plate and a light source optically coupled to the light guide plate, the light guide plate comprising a bottom surface, a light emitting surface opposite to the bottom surface, and a plurality of side surfaces interconnected between the bottom surface and the light emitting surface; and
a light pervious paste, the light pervious paste being interconnected between two adjacent side surfaces of each two neighboring light guide plates.

2. The light source module as claimed in claim 1, wherein the difference between a refractive index of the light pervious paste and that of the light guide plates is less than 0.1.

3. The light source module as claimed in claim 1, wherein the light pervious paste is a UV-cured paste.

4. The light source module as claimed in claim 1, wherein the light pervious paste comprises a plurality of reflective particles dispersed therein.

5. The light source module as claimed in claim 4, wherein the reflective particles are silicon dioxide particles.

6. The light source module as claimed in claim 1, wherein each light guide plate has a recess defined in the bottom surface, and part of the light source is received in the recess.

7. The light source module as claimed in claim 1, wherein each bottom surface has a plurality of scattering dots formed thereon.

8. The light source module as claimed in claim 1, wherein each bottom surface has a reflective layer formed thereon.

9. The light source module as claimed in claim 1, wherein each light emitting surface has a plurality of V-shaped recesses defined therein.

10. A light source module comprising:
a plurality of light guide plates, each light guide plate comprising a bottom surface, a light emitting surface opposite to the bottom surface, and a plurality of side surfaces connected between the bottom surface and the light emitting surface, the light guide plates being assembled together to form a light guide plate module, the light emitting surfaces of the light guide plates being arranged to be coplanar at a first side of the light guide plate module, and the bottom surfaces being arranged to be coplanar at an opposite second side thereof, a plurality of interfacial gaps being formed at opposite side surfaces of each two neighboring light guide plates;
a plurality of light sources for illuminating the light guide plates; and
a light pervious paste applied between each two adjacent light guide plates and completely filling the interfacial gaps.

11. The light source module as claimed in claim 10, wherein the difference between a refractive index of the light pervious paste and that of the light guide plates is less than 0.1.

12. The light source module as claimed in claim 10, wherein the light pervious paste is a UV-cured paste.

13. The light source module as claimed in claim 10, wherein the light pervious paste comprises a plurality of reflective particles dispersed therein.

14. The light source module as claimed in claim 13, wherein the reflective particles are silicon dioxide particles.

15. The light source module as claimed in claim 10, wherein each light guide plate has a recess defined in the bottom surface, and part of the light source is received in the recess.

16. The light source module as claimed in claim 10, wherein each bottom surface has a plurality of scattering dots formed thereon.

17. The light source module as claimed in claim 10, wherein each bottom surface has a reflective layer formed thereon.

18. The light source module as claimed in claim 10, wherein the light emitting surface of each light guide plate has a plurality of V-shaped recesses defined therein.

19. A light source module comprising:
a first light emitting unit comprising a first light guide plate and a first light source optically coupled to the first light guide plate, the light guide plate comprising a first surface;
a second light emitting unit comprising a second light guide plate and a second light source optically coupled to the second light guide plate, the light guide plate comprising a second surface configured for connecting the first light guide plate, the first surface and the second surface cooperatively defining a gap; and
a light pervious paste applied between the first and second surfaces and completely filling the gap.

20. The light source module as claimed in claim 19, wherein the light pervious paste comprises a plurality of reflective particles dispersed therein.
